(19) United States
(12) Patent Application Publication
(10) Pub. No.: US 2008/0320403 A1
(43) Pub. Date: Dec. 25, 2008

(54) Accessing data using its chart symbols

(76) Inventor: Nechemia Glaberson, Overland Park, KS (US)

Correspondence Address: MARTIN D. MOYNIHAN d/b/a PRTSI, INC., P.O. BOX 16446, ARLINGTON, VA, 22215, US

(21) Appl. No.: 11/819,120

(22) Filed: Jun. 25, 2007

(51) Int. Cl. G06F 3/048

(52) U.S. Cl. 715/763

(57) ABSTRACT

A method for data representation by an icon that graphically depicts numerical relations within the data, comprising (a) deriving a chart of the data; (b) generating an icon as an object comprising a displayable image depicting the chart; and (c) associating the icon with the data.

### FIELD OF THE INVENTION

The invention relates to identifying and accessing data by symbols. Some embodiments relate to data representation by small pictorial elements such as icons.

### BACKGROUND OF THE INVENTION

Since the introduction of Graphical User Interfaces (GUI) it is a common practice to represent files, or other objects, by small pictorial symbols—usually known as ‘icons’.

Whereas icons are just arbitrary signs akin to the name of a file, a type or an object, visual data such as images, pictures, drawings and text may be represented by the data itself in a reduced format—usually known as ‘thumbnails’.

These basic concepts have been enhanced and elaborated, varying from the familiar ‘animated GIF’ and reduced web pages to more advanced manipulation. Some enhancements are described, for example, in US2004205629, US2003020763, U.S. Pat. No. 6,496,206, US2004119756 US2006085743, EP1283482 and EP1096793, the disclosures of which are incorporated herein by reference.

### SUMMARY OF THE INVENTION

Generally, relations and meaning within or between numerical data may be revealed or comprehended by presenting the data graphically, typically by various charts or graphs (hereinafter collectively referred to as ‘charts’). A chart may reveal contents for a whole data set, or within its parts, or with relations to other parts of other sets. Furthermore, different charts may reveal different aspects in the same data, for example a trend versus a distribution.

Numerical data refer to data such as acquired in experimental laboratories, test facilities, industrial control and monitoring, or otherwise collected such as in economics, accounting and medicine, or mathematically derived.

An aspect of some embodiments of the invention relates to data representation in an application display, or a window, or additional viewing regions such as the desktop, by an icon or other symbol depicting graphically numerical relations within the data.

In exemplary embodiments of the invention, the icon depicts a chart of the data.

Optionally, the icon may depict a plurality of charts of the data, optionally displaying one at a time.

Optionally, a plurality of icons may represent the same data, or part of it, possibly by different depictions.

Optionally, the icon depicts a chart that is characterized by a set of parameters.

In exemplary embodiments of the invention, the icon is associated with charting parameters related to the icon depiction.

Optionally, the icon may import and associate some charting parameters associated with another icon, the imported parameters effecting a different graphical depiction of the relations in the data.

In exemplary embodiments of the invention, an action applied on the icon (e.g. double-click or Enter key) activates a display of a chart of the data related to the iconic depiction. Optionally the action is applied programmatically, for example, by calling an API, or another programming interface, to act on the data.

Optionally, at least some of the display characteristics resemble the icon depiction. Optionally, at least some of the display characteristics resemble the chart from which the icon depiction was derived.

Another aspect of some embodiments of the invention relates to data representation by an icon that activates an operation utilizing or effecting the numerical values of the data it represents.

In exemplary embodiments of the invention, the operation may comprise an arithmetic or logical or presentation or management operation to be performed on the data. For example, adding known values to the data, subtracting the average value of the data from each data element, or transposing the order of the data elements.

In exemplary embodiments of the invention, the icon visually suggests the operation. Optionally, the visual suggestion comprises a chart of the data. Optionally the visual suggestion comprises a sign or illustration. Optionally, the operation is suggested by text.

In exemplary embodiments of the invention, the operation is activated upon a defined standard interactive action applied to the icon, for example, Enter key or double-click.

In exemplary embodiments of the invention, the icon activates a plurality of operations.

Optionally, the operation is selected from a list. Optionally, the list is generated via the icon responsive to an action on the icon.

For example, a right-click opens a menu comprising the available (defined) operations pertaining to the data. Selecting and activating an operation, e.g. by double-click or click (selection) followed by Enter, will perform the operation on the data.

Optionally, a list of the plurality of operations is presented alongside the icon for selection and activation.

Optionally, the list is presented and the operation selected by other methods, for example, a list of operations in a common dialog.

Optionally, a plurality of operations is available and the operation performed is responsive to an action applied to the icon (e.g. double-click, wheel-scroll, mid-button, Alt-click, Fn key). For example, mid-button averages the data and wheel-scroll sequentially rotates the positions of the data elements in a series.

In exemplary embodiments of the invention, a plurality of icons representing the same data, and optionally with similar or identical depiction, wherein each icon activates a different operation.

In exemplary embodiments of the invention, an icon may activate other applications. For example, invoking a spreadsheet application (such as Microsoft Excel) and loading the associated data and, optionally invoking an operation inside the application such as a chart or an arithmetic operation.

In exemplary embodiments of the invention, the action is applied programmatically, for example, by calling an API, or another programming interface, which automatically acts on the data.

An aspect of some embodiments of the invention relates to activating at least one operation between a plurality of data by icons representing the data.

Optionally, the icons represent the data by graphically depicting numerical relations within the data.

In exemplary embodiments of the invention, an operation between data sets is activated by dragging at least one icon onto another. Optionally, a list of available operations between the data is presented, and an operation may be selected and activated. Optionally or alternatively, a default operation is activated automatically. Alternatively or additionally, a key combination activates the operation, such as Control- or Alt- or mouse button and key combination. In exemplary embodiments of the invention, selecting a plurality of icons and then applying an action, e.g. Ctrl-Enter or double-click to activate a default operation such as addition of the data sets. Optionally or alternatively, a list of available operations between the data is presented, and an operation may be selected and activated.

In exemplary embodiments of the invention, moving an icon or a plurality of icons onto a certain object (e.g. an icon) activates an operation on the data represented by the moved icon or icons, the operation is associated with the certain object. Optionally or additionally, the operation is symbolically depicted on that certain object, for example, by a ‘plus’ sign for addition. Another example is dragging an icon over a printer icon, consequently printing the data in a pre-defined format associated with the icon.

Some examples of operations activated by a plurality of icons are adding the respective elements in corresponding data series, subtracting the average of one data (e.g. noise level) from the elements of the other, merging or concatenation the data, scaling the data according to the common lower or upper limit, a correlation between the data, and so forth.

In exemplary embodiments of the invention, dragging an icon or icons over an application icon such as a spreadsheet (e.g. Microsoft Excel) will activate the application and load the associated data. Optionally, an operation inside the application such as a chart or an arithmetic operation is invoked.

In exemplary embodiments of the invention, the original storage of data represented by the icon is not altered by operations performed using the icon.

For example, arithmetic operation on the data, or with combination with other data, will produce a new data set for the result. Optionally an icon will be created depicting a chart of the new data.

In exemplary embodiments of the invention, the original storage data represented by the icon is altered due to operations performed using the icon. Optionally, the alteration is after a warning. Optionally, the operation is explicitly defined to alter the data.

In exemplary embodiments of the invention, the icon may be used similarly to conventional icons or thumbnails. For example, dragging an icon to a folder will move/copy the represented data set to that folder, deleting or moving to the recycle-bin (‘trash bin’) will delete the data. The deleted data may optionally be recovered.

### BRIEF DESCRIPTION OF THE DRAWINGS

Non-limiting examples of embodiments of the present invention are described with reference to figures listed below. In the drawings which follow, identical or equivalent structures, elements, or parts that appear in more than one drawing are generally labeled with the same numeral in all the drawings in which they appear. Dimensions of components and features shown in the figures are chosen for convenience and clarity of presentation and are not necessarily shown to scale.

FIG. 1A. illustrates a chart of data comprising a plurality of series, wherein relations within the data elements are revealed, in accordance with exemplary embodiments of the invention;

FIG. 1B illustrates an icon derived from the chart of FIG. 1A, depicting graphically numerical relations within the data by presenting some prominent features of the chart, in accordance with exemplary embodiments of the invention;

FIG. 1C illustrates an icon derived from the chart of FIG. 1A, depicting graphically numerical relations within the data by presenting some prominent features of the chart similarly to FIG. 1B, but modifying a feature, in this case, the chart colors, in accordance with exemplary embodiments of the invention;

FIG. 2 illustrates actions involved to derive an icon as an object with a graphical depiction and associated with data linkage and chart parameters, in accordance with exemplary embodiments of the invention;

FIG. 3 illustrates a presentation of icons, exemplified by an application menu where tiny icons appear in the menu alongside their respective data file names, and a selected entry displays a larger icon at the side, in accordance with exemplary embodiments of the invention;

FIG. 4 illustrates a list of icons as they may appear in an application panel, demonstrating another size of the icons and accompanying information of the data, in accordance with exemplary embodiments of the invention;

FIGS. 5A and 5B illustrate two icons depicting the same data by two different charts, in accordance with exemplary embodiments of the invention;

FIG. 6 illustrates an icon as an object and the relations between the icon object and some of its associated elements, in accordance with exemplary embodiments of the invention;

FIG. 7 illustrates an icon as an object with an operation activation set and the relations between the icon object and some of its associated elements, in accordance with exemplary embodiments of the invention;

FIG. 7A illustrates the result of applying an addition operation on elements of data, in accordance with exemplary embodiments of the invention;

FIG. 8 illustrates an icon of data series and a list of operations that is presented, the list comprising also corresponding keyboard and mouse (or similar device) actions, in accordance with exemplary embodiments of the invention; and

FIG. 9 illustrates an icon as an object combining both display and operation parameters, as well as auxiliary information, in accordance with exemplary embodiments of the invention.

### DETAILED DESCRIPTION OF EMBODIMENTS OF THE INVENTION

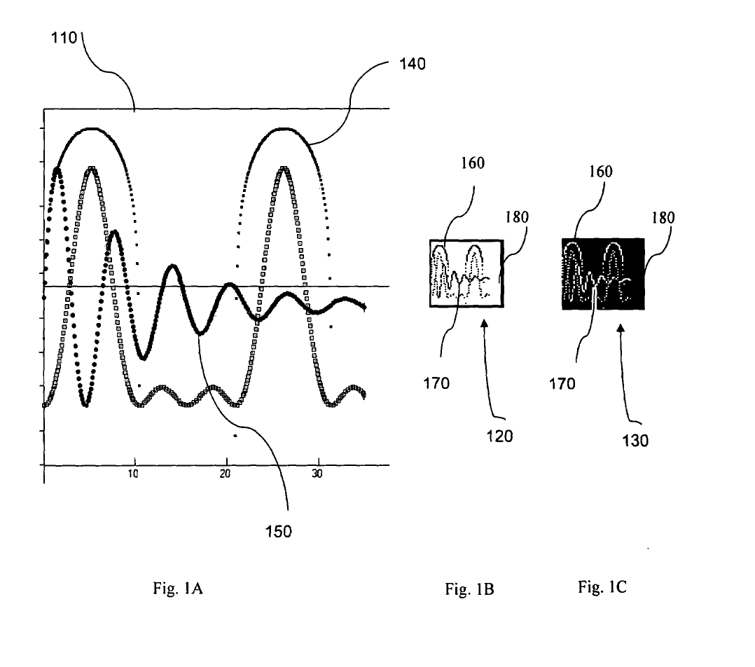

FIG. 1A illustrates a chart 110 of data comprising a plurality of series, wherein relations within the data elements are revealed. FIG. 1B illustrates an icon 120 derived from chart 110, depicting graphically numerical relations within the data by presenting some prominent features 140 and 150 of the chart as 160 and 170, respectively, over a background 180 color.

FIG. 1C is similar to FIG. 1B, wherein the background color and chart color (e.g. color of 160 and 170) is modified relative to the original chart to make prominent features 160 and 170 more noticeable. Similarly to FIG. 1B, chart 110 was analyzed for prominent features 140 and 150, but different coloring was determined for depicting the prominent features, as exemplified in the dark background and bright prominent features 160 and 170.

In this manner, icons 120 and 130 visually represent the data elements revealed in chart 110.

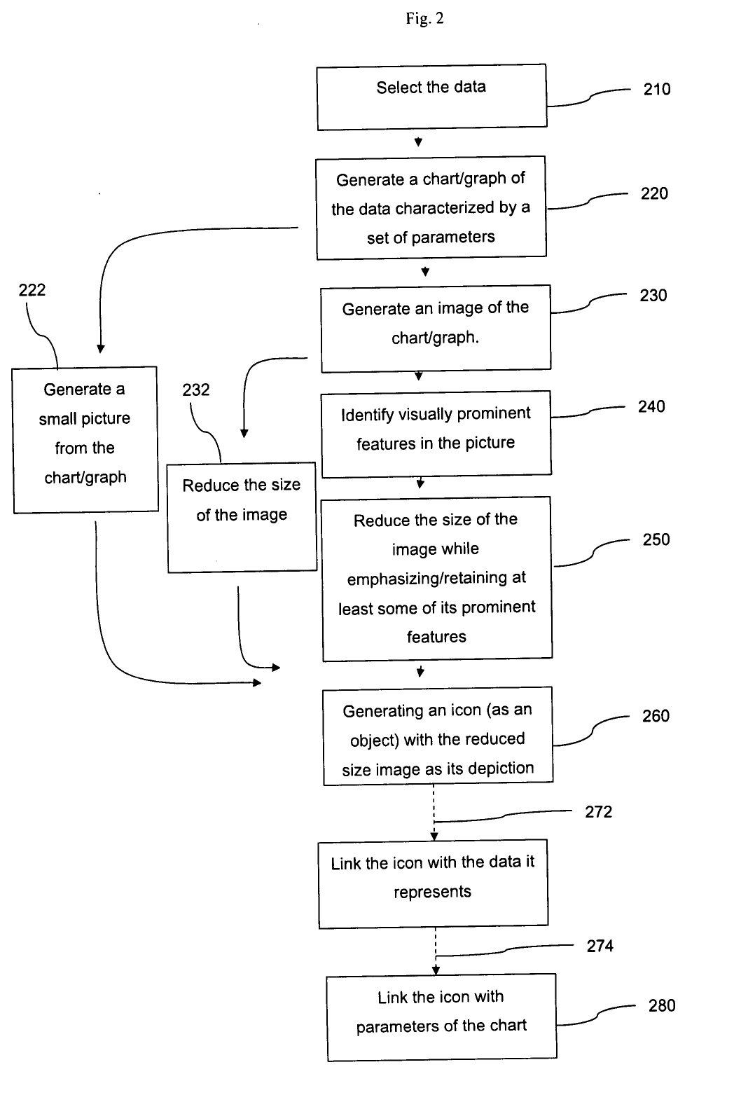

FIG. 2 illustrates actions involved to derive an icon as an object with a graphical depiction and associated with data linkage and chart parameters, in accordance with exemplary embodiments of the invention.

In exemplary embodiments of the invention, a particular sequence of actions is performed as follows. In other exemplary embodiments of the invention, there are shortcuts or variations, or optional actions relative to that particular sequence, as described subsequently.

At 210 the data is selected. Optionally, the whole data set is selected, optionally, only a part of the data set is selected. The selection may comprise a plurality of series in the data set or part thereof. Optionally, data from a plurality of data sets may be selected.

At 220 a chart of the selected data is generated. The chart is characterized by a set of parameters (described below). The chart may be generated and displayed on a screen or off-screen or other methods such as meta-file. Optionally or alternatively, the chart may be generated utilizing only the parameters that characterize it.

Examples for chart parameters are type of the chart (e.g. x-t, x-y, pie), range of values, coordinates ranges, size, aspect ratio, colors, line or symbol types, etc.

At 230 is, an image of the chart is generated. For example, the original pixels of the chart, or a part thereof, are arranged in a picture format such as a pixels matrix, a bitmap or any other appropriate format.

Optionally, the chart is not displayed and the chart parameters are used to generate a chart image in a virtual display into a metafile, pixels matrix, bit map or other arrangement. Subsequently, if the format is not appropriate for the picture, it is converted to a desired picture format.

Once the image of the chart is obtained, at 240 the image is analyzed to identify visually prominent features.

Optionally, techniques such as threshold, contrast, variation of background color or other colors may be used to identify prominent features. Optionally, the spatial properties of the chart are considered. For example, in a damped sinusoid, only the region of large amplitude may be considered (see 150 in FIG. 1A, as an example). Optionally or additionally, the data may be used to identify prominent features by operations such as finding high derivatives, max-min values difference, etc.

The regions of the prominent features, marked by location, color brightness or a combination, are noted for optional later use.

At 250 the image obtained at 230 is reduced in size for use in the icon.

Optionally, a fraction of the picture pixels are selected, for instance, 1 out of each 10×10 area of the image. Optionally, other image resolution reduction or re-sampling techniques may be used, like B-Spline filter, triangle filter, Mitchell filter or other filters and techniques known in the art.

Optionally, when reducing the picture, the prominent features noted earlier (at 240) are emphasized. For example, if a prominent feature is a blue line over a gray background, and in picking a central pixel of 10×10 the blue pixel is ignored, then the selected pixel is painted blue. Optionally, in the 10×10 at least one blue pixel, if present, is selected. If other techniques are used, then the corresponding positions of the blue pixels may be found, and at least some are painted blue to make the blue line feature of the chart distinct in the small picture.

Likewise, the gray background may not be so adequate for the blue pixels, so it may be changed to other color, such as yellow, making the blue pixel (line) more distinct.

Optionally, the background is selected and the prominent color is changed, for example, the background is made black, and the blue feature is painted white, yellow or light green, etc.

At 260 an icon is generated as an object of an application, or task, or process, or operating system, or any part of the system organization to which it pertains.

The icon is associated with a visual depiction which comprises the small picture as described at 250.

Optionally or alternatively, as shown at 232, the reduced size image can be generated without determining prominent features.

Optionally or alternatively, as shown at 222, the reduced size image may be generated directly from the chart (e.g. as pixels and/or as a set of definitions), skipping intermediate actions of generating an image of the chart and identification of prominent features.

Optionally the reduction technique used in 232 and/or 222 preserves at least some prominent features of the picture, for example, by maintaining or enhancing contrast at certain regions. Optionally, contrasting features are given relative larger weight in the reduction or re-sampling. Optionally, varying a color or a thickness of features may convey some prominent features of the picture.

Optionally, the chart on screen pixels, or off-screen pixels, or in metafile, is taken as the very pictorial image of the chart, and reduced to a small image as discussed above.

In exemplary embodiments of the invention, the icon may be displayed with various sizes and aspect ratios, and optionally various forms.

For example, on a desktop or a regular application window, the icon size and form may be similar to other icons of the system or application, while in a menu the icons may be smaller. Another example is tool bars or application bars when the icons may be of smaller or larger size than regular icons.

Another example of displaying icons is when an icon is displayed in different aspect ratio to enhance the visibility of the graphical features. Yet another example is giving the icons different forms, (e.g. circle, ellipse, triangle, rhombus, etc.). The different forms may convey an attribute such as the data source, type a group of the depicted data. Likewise, the form may suggest an operation associated with the icon, or any meaning determined by the application or system design.

Similarly, the icons may be displayed with a colored frame around at least part of its perimeter. Likewise, the icon may be displayed over a background of certain shape and color that may improve visibility or may convey some attributes. For example, icons over a certain background may suggest that an operation on the data via the icons is allowed. Or, for example, icons of on the same background may suggest that an operation between the respective data is allowed, but not between data associated with icons on different background.

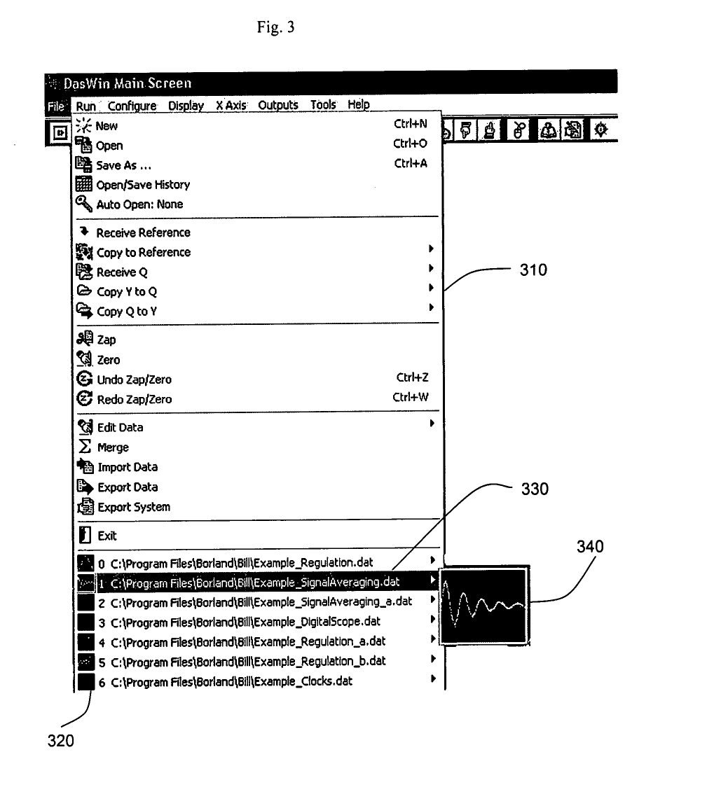

FIG. 3 illustrates a presentation of icons, exemplified by an application menu where tiny icons appear in the menu alongside with their respective data file names, and a selected entry displays a larger icon at the side, in accordance with exemplary embodiments of the invention. This is a non-limiting example of simultaneously presenting small and large icons of the same data (and optionally by the same or different chart). Menu 310 shows tiny icons 320 alongside with their respective data file names, and a selected entry 330 brings about a display of a larger icon 340 at the side.

Tiny icons 320 may appear without larger icons 340, and conversely, the larger icons without the tiny ones. Optionally, any size of icon may be presented.

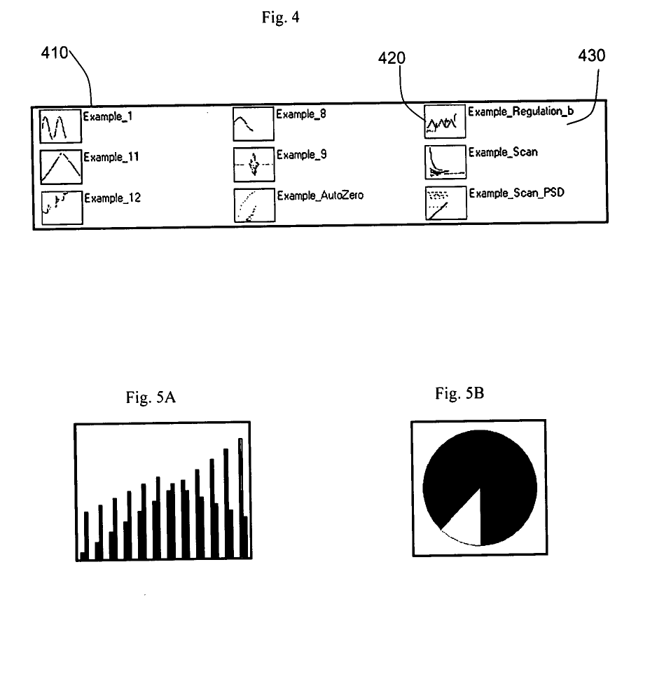

FIG. 4 illustrates a list of icons 420 as they may appear in an application panel (or window) 410, demonstrating another size of the icons and accompanying information 430 of the data, in accordance with exemplary embodiments of the invention.

It should be noted that the accompanying information may optionally comprise a component of the icon object (see later), or it may comprise a part of the depiction (as image), or it may be presented as related information alongside the icon.

The relative sizes of the icons in FIGS. 3 and 4 may optionally be estimated with respect to the text characters size which may be approximately the same.

In exemplary embodiments of the invention, the icons may be presented anywhere in the application display (or operating system GUI, etc.), in any order, size or form.

In exemplary embodiments of the invention, the icon may use ‘transparent’ or ‘translucent’ (partially transparent) colors. Optionally, the operating system provides support for transparency. Alternatively or additionally, the underlying background contents (e.g. of a desktop, window) are used to replace the transparent color, or mix them with the partial transparent color (translucent effect).

The examples and embodiments described are non-limiting and illustrate the flexibility of presenting the icons. Generally, the method and manner of icon presentation is due to the design and operation of the driving program that uses the icons. For example, an operating system, an application, a driver, a process, etc. and are substantially bounded only by the resources of the employed system (hardware and/or software).

Returning to FIG. 2, at 270 the icon, as an object rather than just a visual depiction, is optionally (272) associated with a linkage to the data it graphically represents. The linkage may be used to access to the data, for example, to invoke a display of the data, or manipulate the data, as described later on.

Optionally, the data set as a whole (e.g. a file) is linked. Optionally, only a part of the data is linked by an indication of the range of the related elements in the data set. Optionally, the data comprises elements from a plurality of data sets.

The linkage may comprise a pointer, a path/filename, optionally and additionally with locations within the data sets and ranges of elements.

It should be noted that the data selected for the icon visual depiction (210) may, but not necessarily, be identical with the data linked to the icon. For example, a particular series may be selected for the depiction, but additional series in the data set may be linked.

At 280 the icon, as an object, is associated with parameters that, at least partially, characterize a chart of the data, as described at 220. These parameters may be utilized to generate a respective chart as described later on.

In exemplary embodiments of the invention, action 280 is skipped (274). For example, if the icon object is not intended to be involved in displaying the data, but rather, only to represent it.

In exemplary embodiments of the invention, the icon may depict a plurality of charts of the data, optionally displaying one at a time. Thus, 210-260 are repeated and the small pictures are added to the icon object which is generated once only at 260.

FIGS. 5A and B, that illustrate two icons depicting the same data by two different charts, in accordance with exemplary embodiments of the invention. 5A is a bar chart of two series and 5B is a pie chart of the relative ranges of the two series, and the same icon may show either one of the charts or both of them.

In exemplary embodiments of the invention, a plurality of icons may represent the data, or part of it, possibly by different depictions. Here, for example, each icon may look like one of the icons shown in FIGS. 5A and 5B, that depict the same data by different charts.

In exemplary embodiments of the invention, some of the actions described above may be, at least partially, merged, skipped, or divided into sub-actions, while optional actions may be added. The actions may be substantially adapted to achieve, for example, (a) the icons features as described above, or (b) to exploit flexibilities of the icon object design. Some of the flexibilities are exemplified above, in displaying the icons and/or in association of data.

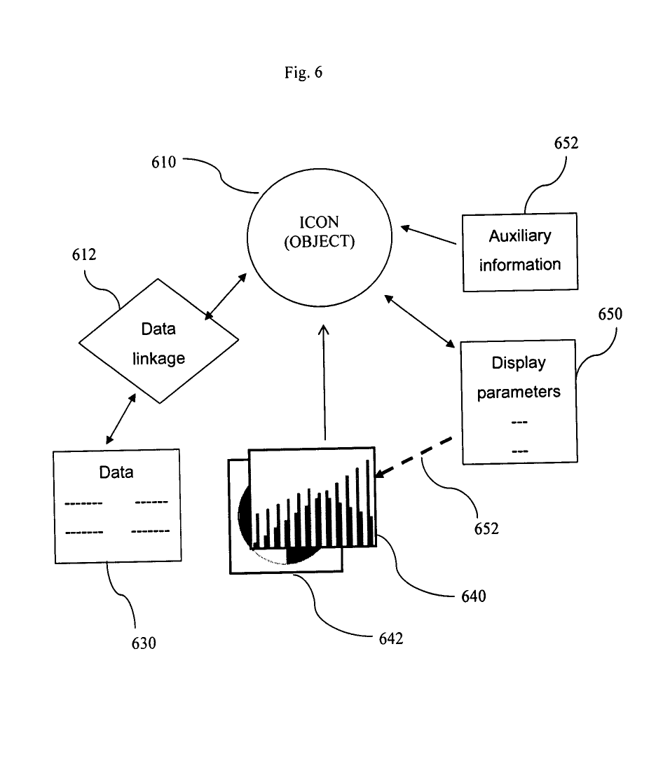

FIG. 6 illustrates an icon 610 as an object and the relations (indicated by regular arrow lines) between icon object 610 and some of its associated elements, in accordance with exemplary embodiments of the invention.

Icon 610 is associated with a small image 640 of a chart of data 630 as a depiction of icon 610. Optionally, additional small images 642 depicting a chart of data 630 are associated, as described above. Optionally, icon 610 may present a plurality of small images such as 640 and 642. optionally, one depiction such as 640 and 642 displayed at a time.

Icon 610 is associated with a linkage 612 to data 630. Icon 610 is, optionally, also associated with charting or display parameters 650. Optionally, display parameters 650 effect (652) the appearance of chart depiction 640 (and optionally 642) of data 630. For example, if parameters 650 change, icon 610 depiction 640 of data 630 will change accordingly, at least partially (e.g. from a bar chart to a line chart). Parameters 650 may change, for example, by importing parameter from another icon, as described below.

Optionally, at least some of display parameters 650 are derived from an actual display of a chart of data 630. Optionally or additionally, at least some of display parameters 650 are obtained from specifications, or parameters, characterizing a chart of data 630.

In exemplary embodiments of the invention, an icon may import and associate some charting parameters associated with another icon, the imported parameters effecting a different graphical depiction of the relations in the data (as described above).

For example, an icon a depicts and is associated with parameters x of a bar chart of its data p. Another icon, icon b, depicts a pie chart of data q by parameters y. Icon b may import the parameters x of icon a, such that icon b will depict data q by a bar chart according to parameters x.

In exemplary embodiments of the invention, the import of charting parameters to one icon from another may be activated by dragging the exporting icon over the importing icon (e.g. icon a over icon b). Optionally, other methods may be used, for example, copying the exporting icon and pasting it on the importing icon.

It should be noted that dragging and pasting may pertain to another type of operations, as described below. The type of operation is responsive to the specification of employing the icons, and further illustrates the flexibly of the icon design.

In exemplary embodiments of the invention, an action applied on an icon activates a display of a chart of the data, optionally, the chart depicted on the icon.

Referring to FIG. 6, in response to an action on icon 610, data 630 is accessed via linkage 612 and a chart of data 630 is generated, according to at least some of parameters 650, in accordance with an embodiment of the invention.

Depending on the extent of storing and using parameters 640, the generated chart may visually resemble depiction 640. Optionally or additionally, the generated chart may resemble a chart from which icon 610 depiction 640 might have been derived (see FIGS. 2 and 280).

Optionally the action on icon 610 is applied by a mouse, such as by double-click. Alternatively or additionally, the action is applied by a keyboard action such as by Enter key. Optionally, the action is applied programmatically, for example, by calling an API or another programming interface.

In exemplary embodiments of the invention, acting on icon 610 activates an operation utilizing or effecting the numerical values of the data it represents.

In exemplary embodiments of the invention, the operation comprises an arithmetic, logical, presentation or management operation to be performed on the data. Optionally, the operation is indicated by at least one parameter associated with the icon (650).

Optionally, a management operation comprises moving the data, rearranging the data, deleting the data and similar operations. Optionally, the deleted data is at least partially recoverable.

In exemplary embodiments of the invention, icon 610 may activate other applications. For example, invoking a spreadsheet application (such as Microsoft Excel) and loading the associated data into the spreadsheet cells. Optionally or additionally, a macro or script is invoked to carry out operations such as presenting a chart of the data in the application or applying arithmetic operation on the data.

In exemplary embodiments of the invention, icon object 610 may be associated with auxiliary data 652. For example, textual information relating to the data such as the source of the data, acquisition time, or definitions such as printing format, etc.

Optionally, icon object 610 provides a mechanism to add comments as part of auxiliary data 652. For example, in response to a pre-defined keyboard and/or mouse (e.g. Shift-click, Shift-F10) a text entry box is opened (or an application such Microsoft Notepad, etc.). The entered text may be saved into auxiliary information 652 of icon object 610.

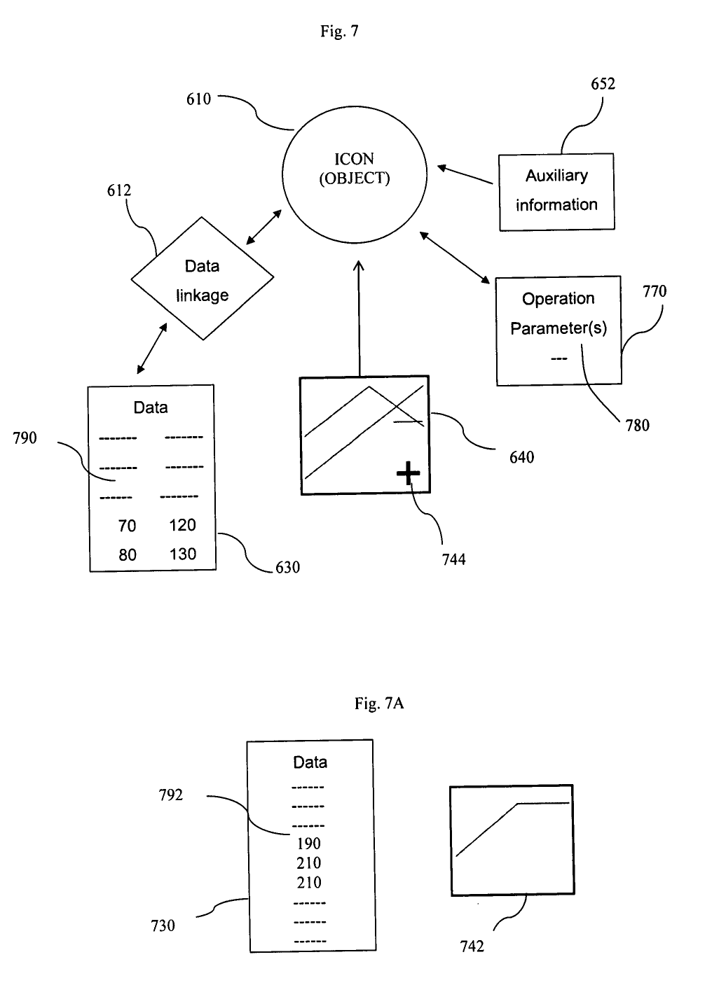

FIG. 7 illustrates an icon as an object with an operation activation set and the relations between the icon object and some of its associated elements, in accordance with exemplary embodiments of the invention.

Icon 610 as an object comprises an operation activation set 770. Operation activation set comprises at least one operation parameter 780, indicating the operation to be performed on elements 790 of data 630.

Optionally, icon depiction 640 comprises a symbol 744, or other illustrations, to suggest the operation.

Assuming, for example, that operation parameter 780 indicates an addition of data elements 790 to corresponding elements in each series of data 730 (symbol 744 as ‘+’ suggests the addition). FIG. 7A illustrates the result of applying the addition operation on elements 790 of data 630 so that data 730 holds elements 792 which are the sum of elements 190.

In exemplary embodiments of the invention, the operation is activated upon a defined standard interactive action applied to the icon, for example, Enter key or double-click.

Referring to FIGS. 7 and 7A, assuming, for example, that operation parameter 780 indicates an addition of data elements 790 as described above, and that no other operation is indicated. Consequently, applying double-click or Enter key action on icon 710 will activate the addition operation resulting in data 732.

Optionally, a corresponding chart 742 of new data 732 is generated (as described earlier) and presented.

In exemplary embodiments of the invention, icon 630 activates a plurality of operations. Optionally, the operations are indicated by parameters 780 of FIG. 7.

In exemplary embodiments of the invention, the operation is selected from a list. Optionally, the list is generated via the icon responsive to an action on the icon, such as right-click.

In exemplary embodiments of the invention, operations parameters 780 are assigned particular operational procedures, interactively or programmatically.

Optionally, a collection of codes for operation procedures (and optionally respective descriptions) is maintained in the operating environment of icons 610 (such as application, process, etc.), and a mechanism is provided to assign the procedures codes to operation parameters 780 of icon 610.

For example, the procedures codes (with respective descriptions) are presented in a list. Selecting an icon and an operation in the list and acting on them, such as by an Enter key, assigns one of parameters 780 with a procedure code. Optionally or additionally, an operation from the list is dragged on the icon. Alternatively or additionally, other assignment methods may be used, such as a definition file (like an INI file), registry entries, and others. Optionally or additionally, the assignment is performed programmatically, such as by an API or another programming interface, optionally using the definition file or registry. Optionally, the assignment carried out in run-time and/or defined in compile-time. Optionally and additionally, descriptions of the procedures is assigned together with the codes.

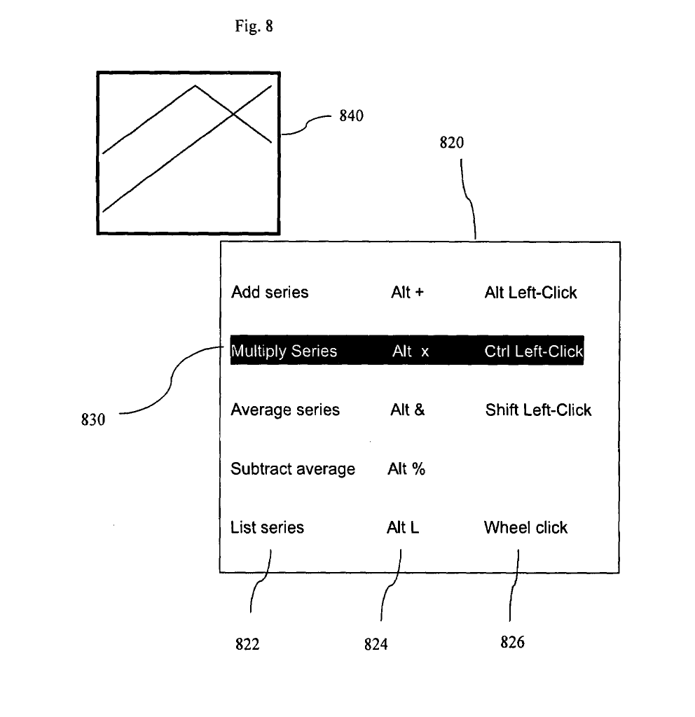

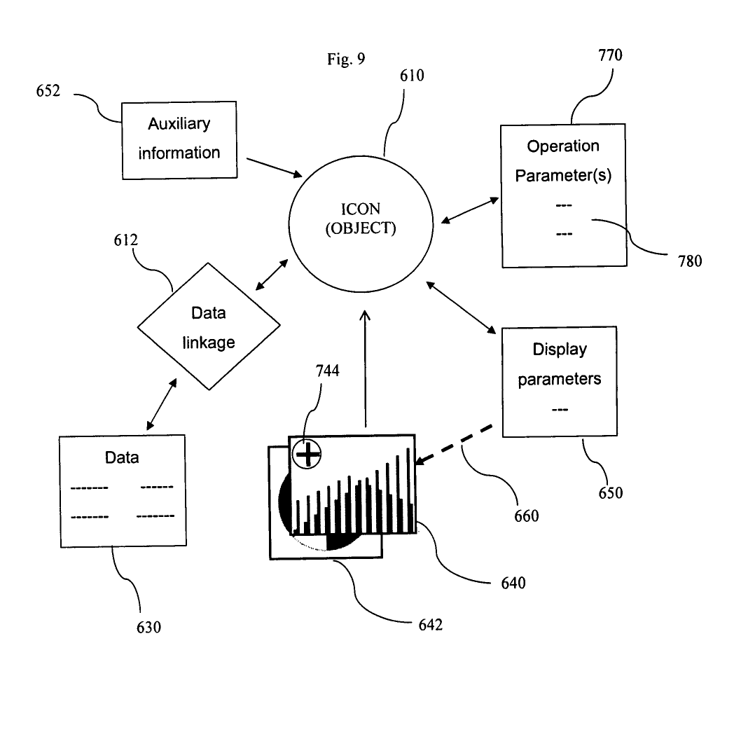

Selecting an operation from those associated with an icon is exemplified with reference to FIG. 8. FIG. 8 illustrates an icon 840 of data series and a list of operations 820 that is presented in response to an action on icon 840, such as right-click, in accordance with exemplary embodiments of the invention.

List 820 comprises a plurality of operations 822 that may be performed on the data series represented graphically by icon 810. Operations 822 may optionally be activated by corresponding plurality of keyboard keys 824 and/or key-mouse-clicks 826. Alternatively or additionally, an operation may be selected (830) and activated by a defined standard interactive action (e.g. Enter key or double-click).

In exemplary embodiments of the invention, a plurality of operations are available, and an operation activated responsive to an action applied to the icon without presenting a list such as 820.

For example, acting on icon 810, with or without list 820, by the keyboard or mouse ‘hot keys’ will activate the corresponding operation. Namely, ‘Alt Plus’ or ‘Alt left-click’ will add the corresponding elements of the series as described above; acting by ‘Alt X’ or ‘Shift left-click’ will multiply them. Likewise, subtracting the average of each series from each of its elements is preformed responsive to a keyboard action only, ‘Alt Percent’, whereas listing the values of the elements is responsive to either a keyboard action, ‘Alt L’, or clicking with the mouse ‘Wheel button’ (or its equivalent in other devices or by other manners).

In exemplary embodiments of the invention, the action is applied programmatically, for example, by calling an API or another programming interface.

In exemplary embodiments of the invention, an operation between data is activated by a plurality of icons representing the data. For example, by one or more of (a) dragging at least one icon onto another, (b) selecting at least one icon and pasting it into another, (c) selecting a plurality of icons and then applying an action, e.g. Ctrl-Enter, or (d) moving a plurality of icons to a certain object (e.g. some icon, optionally suggesting the operation by its depiction). Optionally or additionally, other methods may be applied, such as programmatically.

In exemplary embodiments of the invention, the operation comprises at least one of an arithmetic, logical, presentation or management operation applied to at least one element in the data. For example, adding data elements between the data, finding a max or min of the values of the data, deleting the data (optionally at least partially recoverably), or merging the data.

Referring to FIG. 7 and assuming that operation parameter 780 of icons 610 indicates an addition, for example, adding data elements 790 of data 630 represented by one icon 610 (icon a) to corresponding elements of another icon 610 (icon b).

In exemplary embodiments of the invention, dragging icon a over icon b will activate the operation, and vice versa, dragging icon b over icon a will also add the data elements.

Optionally, the dragging order (icon a over icon b, or vice versa) may be significant, for example, in a subtraction or division.

For example, dragging icon a over icon b may subtract data 630 of icon a from data 630 of icon b. Optionally, the order of operands 630 relative to the operation (e.g. what is subtracted) is defined in the underlying program (e.g. application, system, driver). Optionally or alternatively, the order is defined in icon 630, optionally, according to the dragging operation.

Optionally, dragging both icons a and b over another icon 610 (icon c) will add the corresponding elements of the data represented by the three icons, a, b and c, and so forth.

In exemplary embodiments of the invention, the action is not activated immediately (as described above), but, rather, a list (or menu) is presented and an action is selected or activated by a ‘hot’ key as illustrated in FIG. 8 and the respective description. It should be noted that FIG. 8 and its description relate to data associated with one icon 610, whereas here it applies to data associated with a plurality of icons. Yet, the methods are similar and not described here in detail for brevity and clarity.

FIG. 9 illustrates an icon as an object combining both display and operation parameters, as well as auxiliary information, in accordance with exemplary embodiments of the invention.

The illustration comprises the optional components of icon 610 as discussed above, illustrating the structure and of an exemplary icon. The illustration convey the resources available to icon 610 and indicates the flexibility of display and operations involved, some of which were discussed and exemplified above.

In exemplary embodiments of the invention, different combination of the associated members of icon 610 are applied. For example, display parameters 650 or operation parameters set 770 may be absent, with elimination of their respective functionality.

In exemplary embodiments of the invention, when data elements are affected by operations as described above, the original data is preserved. For example, referring to FIGS. 7 and 7A, data 732 with elements 792 is generated without affecting original data 730.

Optionally, when an operation is performed between data 630 of a plurality of icons, data 630 of one icon may modified to hold the result. Optionally, when icons are dragged or pasted into another, data 630 of the latter is modified.

Optionally or alternatively, resultant data 732 replaces one of original data 630, optionally data 730 of icon 610 over which other icons were dragged (e.g. icon c of the latter example). Optionally or alternatively, the affected data or resultant data is stored separately of the original data. Optionally or additionally, an icon with a depiction of a chart of the resultant data is generated and, optionally, presented.

In exemplary embodiments of the invention, at least part of the functionality of icon 610 as described above is provided as an add-on module. The add-on module may provide programming interface (e.g. API or library routines or DLL entry points, etc). The programming interface may be accessed by programs such as an application, an operating system or its component, a driver, or substantially any process or task.

Optionally, the add-on module is a single programming entity (such as an executable image). Optionally or alternatively, it may comprise a plurality of components, not necessarily of the same nature. For example, one component is a service process of the operation system and another is a library (such as DLL or a COM) accessible by applications. Optionally or additionally, the add-on module may be used by web applications and scripts.

In exemplary embodiments of the invention, the add-on module is a software coded on hardware such as CD, hard disk, UFD (‘disk-on-key), internal memory, etc. Optionally or additionally, the module is comprised in a firmware such as ROM. Optionally or additionally, at least partly, the module is comprised in a hardware module.

In exemplary embodiments of the invention, the add-on module is installed locally for local access and functionality. Alternatively or additionally, at least part of the module is installed on a remote station (e.g. a server) and other stations may use its functionality as client applications. Optionally, the client station uses an interface component comprised in the add-on module. Optionally or additionally, the add-on module may be employed as COM and/or DCOM, or similar mechanisms such as RPC (remote procedure call).

Optionally, the remote invocation of the add-on module is achieved over a network, such as LAN or WAN. Optionally or additionally, the network is a wireless network (e.g. WiFi, Bluetooth or cellular). Optionally, a standard protocol such as TCP/IP is used, Optionally or alternatively, other standard or non-standard protocols are used. Optionally or additionally, the remote invocation may be achieved over an Internet connection. Optionally, the module interacts over the internet, optionally employing a web application.

In exemplary embodiments of the invention, some of the functions described above are carried out by a part or component of the module suitable for the functions.

In exemplary embodiments of the invention, the module or part thereof may interact with an existing system or sub-system, or application or processes or such objects by other methods. For example, as part of a compilation or co-routines.

In the description and claims of the present application, unless otherwise specified, the terms ‘chart’ and ‘graph’ may be synonymous. In the description and claims of the present application, the term ‘icon’ refers to a small, relative to the screen, pictorial display element, not necessarily of the size of a standard icon of the underlying system. The term ‘icon’ and ‘icon object’ refer to an icon which is a programmatic object, even when regarding only the visual aspect (depiction) of the icon, unless otherwise specified. In the description and claims of the present application, referring to key or keyboard implies any equivalent, such as ‘virtual’ keyboard/keypad known in PDA or Windows. In the description and claims of the present application, referring to a mouse and clicks implies any equivalent, such as a tablet or a pad (as known in some portable computers), arrow keys with or without additional keys or touch screen or any other device or method applicable for pointing and actions related to the pointed location.

In the description and claims of the present application, each of the verbs “comprise”, “include” and “have” as well as any conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to necessarily limit the scope of the invention. In particular, numerical values may be higher or lower than ranges of numbers set forth above and still be within the scope of the invention. The described embodiments comprise different features, not all of which are required in all embodiments of the invention. Some embodiments of the invention utilize only some of the features or possible combinations of the features. Alternatively and additionally, portions of the invention described/depicted as a single unit may reside in two or more separate physical entities which act in concert to perform the described/depicted function. Alternatively and additionally, portions of the invention described/depicted as two or more separate physical entities may be integrated into a single physical entity to perform the described/depicted function. Variations of embodiments of the present invention that are described and embodiments of the present invention comprising different combinations of features noted in the described embodiments can be combined in all possible combinations including, but not limited to use of features described in the context of one embodiment in the context of any other embodiment. The scope of the invention is limited only by the following claims.

All publications and/or patents and/or product descriptions cited in this document are fully incorporated herein by reference to the same extent as if each had been individually incorporated herein by reference or if they were reproduced in full herein.

1. A method for data representation by an icon that graphically depicts numerical relations within the data, comprising:
(a) deriving a chart of the data;
(b) generating an icon as an object comprising a displayable image depicting the chart; and
(c) associating the icon with the data.

2. A method according to claim 1, comprising:
(a) selecting the data;
(b) generating a chart of the data;
(c) generating an image of the generated chart;
(d) generating an icon with a linkage to the data, the icon depicting a reduced size version of the chart.

3. A method according to claim 2, wherein generating a chart comprises determining parameters that, at least partially, characterize the chart.

4. A method according to claim 2, wherein generating an image of the generated chart comprises determining pixels adapted for presentation such that the presentation visually depicts the chart.

5. A method according to claim 2, wherein generating an icon comprises associating the icon with at least one parameter characterizing, at least partially, the generated chart.

6. A method according to claim 2, wherein depicting a small version of the chart comprises emphasizing visually prominent features in the chart such that at least one prominent feature is substantially recognizable in the small version.

7. A method according to claim 1, wherein the icon depicts a plurality of charts, displaying at least one at a time.

8. A method according to claim 1, wherein the icon is associated with at least one parameter that at least partially characterizes a chart it depicts.

9. A method according to claim 1, wherein a first icon imports from a second icon at least one parameter that at least partially characterizes a chart depicted by the second icon, the imported parameters effecting a graphical depiction of relations in the data represented by the first icon.

10. A method according to claim 1, wherein an action applied on the icon activates a display of a chart of the data, the action comprises at least one of a keyboard, mouse, program, or a combination thereof.

11. A method according to claim 10, wherein at least one of the display characteristics substantially resembles a depiction of the icon.

12. A method according to claim 1, wherein moving the icon to another location moves or copies the data to that location.

13. A method for numerical data representation by an icon that activates one or more operations affecting at least one numerical value of the data it represents.

14. A method according to claim 13, wherein the activation is responsive to an action applied on the icon, the action comprises at least one of a keyboard, mouse, program, or a combination thereof.

15. A method according to claim 13, wherein the operations comprise at least one of an arithmetic, logical, presentation or management operation.

16. A method according to claim 13, wherein the icon visually suggests an operation.

17. A method according to claim 13, wherein the operations are selected from a list generated responsive to an action on the icon, the action comprising at least one of a keyboard, mouse, program, or a combination thereof.

18. A method according to claim 13, wherein affecting values of the data effects a generation of an icon depicting a chart of the affected data.

19. A method for activating at least one operation between a plurality of sets of data utilizing icons representing the sets of data.

20. A method according to claim 19, wherein the activation comprises dragging at least one icon onto another.

21. A method according to claim 19, comprising selecting at least one icon and pasting into another.

22. A method according to claim 19, comprising selecting a plurality of icons and then applying an action.

23. A method according to claim 19, comprising moving a plurality of icons to a certain object.

24. A method according to claim 19, comprising a programmatic activation.

25. A method according to claim 22, wherein an action comprises at least one of a keyboard, mouse, program, or a combination thereof.

26. A method according to claim 19, wherein the operation comprises at least one of an arithmetic, logical, presentation or management operation.

27. A method according to claim 19, wherein the operations are selected from a list generated responsive to an action on the icon, the action comprising at least one of a keyboard, mouse, program, or a combination thereof.

28. A method according to claim 19, wherein the operation on the data effects a generation of an icon depicting a chart of data effected by the operation.

29. A module that links to numerical data and adapted to generate one or more icons that represent the data.

30. A module according to claim 29, wherein the icon graphically depicts numerical relations within the data.

31. A module according to claim 29, wherein the icon effects at least one operation on the data it represent or between the data it represents and data represented by other one or more icons.

32. A module according to claim 29, wherein the module is at least partially implemented by at least one of a software program coded in a storage device, hardware circuits or a combination thereof.

33. A module according to claim 29, wherein at least a part of the module interacts and/or integrates with other software and/or hardware objects.

34. A module according to claim 29, wherein at least a part of the module is adapted to operate remotely.

35. A module according to claim 29, adapted to perform the method of claim 1.
